(19) United States
(12) Patent Application Publication
(10) Pub. No.: US 2025/0278185 A1
(43) Pub. Date: Sep. 4, 2025

(54) DISPLAY APPARATUS FOR DISPLAYING PREDICTED TRAJECTORY AND CONTROLLING METHOD THEREOF

(71) Applicant: SAMSUNG ELECTRONICS CO., LTD., Suwon-si (KR)

(72) Inventors: Serhii NESTERENKO, Kyiv (UA); Dmytro SYDORENKO, Kyiv (UA); Svitlana ALKHIMOVA, Kyiv (UA)

(73) Assignee: SAMSUNG ELECTRONICS CO., LTD., Suwon-si (KR)

(21) Appl. No.: 19/097,498

(22) Filed: Apr. 1, 2025

Related U.S. Application Data
(63) Continuation of application No. PCT/KR2025/099438, filed on Feb. 18, 2025.

(30) Foreign Application Priority Data
Feb. 29, 2024 (KR) 10-2024-0029780

(51) Int. Cl. G06F 3/04883; G09G 3/20

(52) U.S. Cl. CPC G06F 3/04883; G09G 3/20; G09G 2320/0252; G09G 2354/00

(57) ABSTRACT

A display apparatus includes: a memory storing one or more instructions; a display panel comprising a touch sensor; and at least one processor, wherein the one or more instructions, when executed by the at least one processor, cause the display apparatus to: obtain a first input point corresponding to a first touch on a screen, obtain a second input point corresponding to a second touch on the screen, control the display panel to display a touch trajectory based on the first input point and the second input point in a next frame subsequent to the second frame, obtain a predicted trajectory based on the first input point and the second input point, display the predicted trajectory with an adjusted length with the touch trajectory in the next frame such that the touch trajectory and the predicted trajectory with the adjusted length form a continuous trajectory in the next frame.

### CROSS-REFERENCE TO RELATED APPLICATION(S)

This application is a bypass continuation of International Application No. PCT/KR2025/099438, filed on Feb. 18, 2025, which is based on and claims priority to Korean Patent Application No. 10-2024-0029780, filed on Feb. 29, 2024, in the Korean Intellectual Property Office, the disclosures of which are incorporated by reference herein in their entireties.

### BACKGROUND

### 1. Field

The present disclosure relates to a display apparatus and a controlling method thereof, and more particularly, to a display apparatus that displays a predicted trajectory by taking into account an area where a touch is detected and a controlling method thereof.

### 2. Description of the Related Art

Recently, with technological advances in the field of display apparatuses, various types of display apparatuses have been developed and popularized.

The trend is to improve productivity by not only viewing content through a display apparatus, but also using the display apparatus for a variety of tasks, such as taking notes with a stylus pen.

However, when a touch is performed via a stylus pen, there is a delay (e.g., input lag) before the display apparatus recognizes the touch and displays a trajectory corresponding to the touch. The input lag increases user inconvenience and degrades the user experience because the input lag varies depending on where on the screen of the display apparatus the touch is detected.

There is a need for a method of maintaining a constant delay time and displaying a predicted trajectory more appropriately, regardless of where a touch is detected on a display apparatus, to provide an effect similar to that of no delay time occurring between the time a touch is detected and the time of displaying the touch trajectory corresponding to the touch.

### SUMMARY

A display apparatus includes: memory storing one or more instructions; a display panel including a touch sensor; and at least one processor operatively coupled to the memory and the display panel and configured to execute the one or more instructions, wherein the one or more instructions, when executed by the at least one processor, cause the display apparatus to: based on a first touch on a screen of the display panel being detected through the touch sensor while a first frame from among a plurality of frames included in an image is displayed by the display panel, obtain a first input point corresponding to the first touch, based on a second touch on the screen being detected while a second frame from among the plurality of frames is displayed by the display panel, obtain a second input point corresponding to the second touch, display, on the display panel, a touch trajectory based on the first input point and the second input point in a next frame subsequent to the second frame, obtain a predicted trajectory based on the first input point and the second input point, adjust a length of the predicted trajectory based on coordinate information corresponding to the first touch within the screen, and display, on the display panel, the predicted trajectory with the adjusted length with the touch trajectory in the next frame such that the touch trajectory and the predicted trajectory with the adjusted length form a continuous trajectory in the next frame.

The one or more instructions, when executed by the at least one processor, cause the display apparatus to: update the display panel from a top to bottom direction or a left to right direction during a refresh rate and display each of the plurality of frames sequentially, and obtain a display time between a time of updating the display panel for displaying the next frame and a time of displaying the touch trajectory in the next frame based on a ratio of the coordinate information to a size of the screen.

The one or more instructions, when executed by the at least one processor, cause the display apparatus to: based on the display panel being updated from the top to bottom direction during the refresh rate, obtain the display time based on a ratio of a y-axis coordinate included in the coordinate information to a height of the screen, and adjust the length of the predicted trajectory based on the display time in the next frame.

The one or more instructions, when executed by the at least one processor, cause the display apparatus to: based on the display panel being updated from the left to right direction during the refresh rate, obtain the display time based on a ratio of an x-axis coordinate included in the coordinate information to a width of the screen, and adjust the length of the predicted trajectory based on the display time in the next frame.

The one or more instructions, when executed by the at least one processor, cause the display apparatus to: obtain a buffering time between a time of detecting the first touch and the time of updating the display panel, and adjust the length of the predicted trajectory based on the buffering time and the display time.

The one or more instructions, when executed by the at least one processor, cause the display apparatus to: obtain a delay time between a time of detecting the first touch and a time of displaying the touch trajectory based on the buffering time and the display time, and adjust the length of the predicted trajectory by comparing a prediction time corresponding to a prediction point included in the predicted trajectory with the delay time.

The one or more instructions, when executed by the at least one processor, cause the display apparatus to, based on a sum of a refresh time corresponding to the refresh rate and the buffering time being less than the prediction time, display a portion of the predicted trajectory by adjusting the length of the predicted trajectory based on the delay time.

The one or more instructions, when executed by the at least one processor, cause the display apparatus to, based on the prediction time being less than a sum of the refresh time and the buffering time, display a portion of the predicted trajectory based on the prediction time, the refresh time, and the display time.

The one or more instructions, when executed by the at least one processor, cause the display apparatus to, based on the delay time being included between a first prediction time corresponding to a first prediction point included in the predicted trajectory and a second prediction time corresponding to a second prediction point in the predicted trajectory, adjust the length of the predicted trajectory to a length between the first prediction point and the second prediction point.

The one or more instructions, when executed by the at least one processor, cause the display apparatus to, based on the display panel performing an adaptive synchronization function, add a time required to perform the adaptive synchronization function to a buffering time.

According to an aspect of the disclosure, a controlling method of a display apparatus, the method including: based on a first touch on a screen of a display panel of the display apparatus being detected while a first frame from among a plurality of frames included in an image is displayed, obtaining a first input point corresponding to the first touch; based on a second touch on the screen being detected while a second frame from among the plurality of frames is displayed, obtaining a second input point corresponding to the second touch; displaying a touch trajectory based on the first input point and the second input point in a next frame subsequent to the second frame, obtaining a predicted trajectory based on the first input point and the second input point; adjusting a length of the predicted trajectory based on coordinate information corresponding to the first touch within the screen; and displaying the predicted trajectory with the adjusted length with the touch trajectory in the next frame such that the touch trajectory and the predicted trajectory with the adjusted length form a continuous trajectory in the next frame.

The method may further include: updating the display panel from a top to bottom direction or left to right direction during a refresh rate and displaying each of the plurality of frames sequentially, and the adjusting the length of the predicted trajectory may include obtaining a display time between a time of updating the display panel for displaying the next frame and a time of displaying the touch trajectory in the next frame based on a ratio of the coordinate information to a size of the screen.

The obtaining the display time may include, based on the display panel being updated from the top to bottom direction during the refresh rate, obtaining the display time based on a ratio of a y-axis coordinate included in the coordinate information to a height of the screen, and the adjusting the length of the predicted trajectory may include adjusting the length of the predicted trajectory based on the display time in the next frame.

The obtaining the display time may include, based on the display panel being updated from left to right during the refresh rate, obtaining the display time based on a ratio of an x-axis coordinate included in the coordinate information to a width of the screen, and the adjusting the length of the predicted trajectory may include adjusting the length of the predicted trajectory based on the display time in the next frame.

The adjusting the length of the predicted trajectory may include: obtaining a buffering time between a time of detecting the first touch and the time of updating the display panel; and adjusting the length of the predicted trajectory based on the buffering time and the display time.

According to an aspect of the disclosure, a non-transitory computer readable medium, has instructions stored therein, which when executed by a processor a display apparatus, cause the processor to execute a method including: based on a first touch on a screen of a display panel of the display apparatus being detected while a first frame from among a plurality of frames included in an image is displayed, obtaining a first input point corresponding to the first touch; based on a second touch on the screen being detected while a second frame from among the plurality of frames is displayed, obtaining a second input point corresponding to the second touch; displaying a touch trajectory based on the first input point and the second input point in a next frame subsequent to the second frame, obtaining a predicted trajectory based on the first input point and the second input point; adjusting a length of the predicted trajectory based on coordinate information corresponding to the first touch within the screen; and displaying the predicted trajectory with the adjusted length with the touch trajectory in the next frame such that the touch trajectory and the predicted trajectory with the adjusted length form a continuous trajectory in the next frame.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a view provided to explain a display apparatus and an input apparatus according to one or more embodiments;

FIG. 2 is a block diagram illustrating configuration of a display apparatus according to one or more embodiments;

FIG. 3 is a view provided to explain input lag occurring in a first area within a screen of a prior art display apparatus;

FIG. 4 is a view provided to explain input lag occurring in a second area within a screen of a prior art display apparatus;

FIG. 5 is a view provided to explain a touch trajectory according to one or more embodiments;

FIG. 6 is a view provided to explain a predicted trajectory according to one or more embodiments;

FIG. 7 is a view provided to explain a buffering time according to one or more embodiments;

FIG. 8 is a view provided to explain a display time according to one or more embodiments;

FIG. 9 is a view provided to explain a delay time according to one or more embodiments;

FIG. 10 is a view provided to explain a display apparatus that displays a predicted trajectory with an adjusted length according to one or more embodiments;

FIG. 11 is a view provided to explain input lag occurring in a display apparatus that updates a frame in various directions according to one or more embodiments; and

FIG. 12 is a flowchart provided to explain a controlling method of a display apparatus according to one or more embodiments.

### DETAILED DESCRIPTION

Hereinafter, the present disclosure will be described in detail with reference to the accompanying drawings.

General terms that are currently widely used are selected as the terms used in the embodiments of the disclosure in consideration of their functions in the disclosure, but may be changed based on the intention of those skilled in the art or a judicial precedent, the emergence of a new technique, or the like. In addition, in a specific case, terms arbitrarily chosen by an applicant may exist, in which case, the meanings of such terms will be described in detail in the corresponding descriptions of the disclosure. Therefore, the terms used in the embodiments of the disclosure need to be defined on the basis of the meanings of the terms and the overall contents throughout the disclosure rather than simple names of the terms.

In the disclosure, the expressions “have”, “may have”, “include” or “may include” indicate existence of corresponding features (e.g., components such as numeric values, functions, operations, or components), but do not exclude presence of additional features.

An expression, “at least one of A or/and B” should be understood as indicating any one of “A”, “B” and “both of A and B.”

Expressions “first”, “second”, “1st,” “2nd,” or the like, used in the disclosure may indicate various components regardless of sequence and/or importance of the components, will be used only in order to distinguish one component from the other components, and do not limit the corresponding components.

When it is described that an element (e.g., a first element) is referred to as being “(operatively or communicatively) coupled with/to” or “connected to” another element (e.g., a second element), it should be understood that it may be directly coupled with/to or connected to the other element, or they may be coupled with/to or connected to each other through an intervening element (e.g., a third element).

Singular expressions include plural expressions unless the context clearly dictates otherwise. In this specification, terms such as “comprise” or “have” are intended to designate the presence of features, numbers, steps, operations, components, parts, or a combination thereof described in the specification, but are not intended to exclude in advance the possibility of the presence or addition of one or more of other features, numbers, steps, operations, components, parts, or a combination thereof.

In exemplary embodiments, a “module” or a “unit” may perform at least one function or operation, and be implemented as hardware or software or be implemented as a combination of hardware and software. In one or more examples, a plurality of “modules” or a plurality of “units” may be integrated into at least one module and be implemented as at least one processor (not shown) except for a ‘module’ or a ‘unit’ that needs to be implemented as specific hardware.

In this specification, a term ‘user’ may refer to a person using an electronic apparatus or a device using an electronic apparatus (e.g., an artificial intelligence electronic apparatus).

Hereinafter, one or more embodiments of the present disclosure will be described in greater detail with reference to the accompanying drawings.

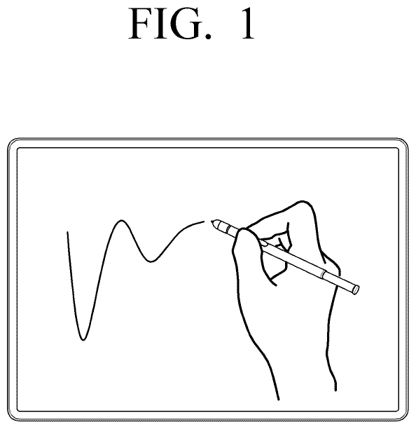

FIG. 1 is a view provided to explain a display apparatus and an input apparatus according to one or more embodiments.

As shown in FIG. 1, a display apparatus 100 may be implemented as a user terminal device, but is not limited thereto. In one or more examples, the display apparatus 100 may be implemented as various types of devices with display capabilities, such as a television, an electric white board display, a video wall, a large format display (LFD), a digital signage, a digital information display (DID), a projector display, or any other suitable display device known to one of ordinary skill in the art.

According to one or more embodiments, the display apparatus 100 may detect a touch, and perform an operation corresponding to the touch.

For example, the display apparatus 100 may provide a handwriting function (or a handwriting input function, a writing function, etc.), and display a trajectory corresponding to a touch (hereinafter, referred to as a touch trajectory).

As shown in FIG. 1, the display apparatus 100 may detect a touch via an input apparatus 200, and display the touch trajectory.

As illustrated in FIG. 1, the input apparatus 200 is a stylus pen for convenience of explanation. However, the embodiments are not limited to a stylus pen, and as understood by one of ordinary skill in the art, the input apparatus 200 may be any type of suitable device known to one of ordinary skill in the art configured to touch the display apparatus 100. In one or more examples, a user's finger may perform the functions of the stylus pen.

When the display apparatus 100 detects a touch using an electrostatic touch method, the input apparatus 200 may be implemented as various types of objects configured to come into contact with the screen on the display apparatus 100 and changing the electrical signal.

In some embodiments, latency may occur between the display apparatus 100 detecting a touch and displaying the touch trajectory. The latency may be referred to as a delay, input lag, or the like.

According to one or more embodiments, the display apparatus 100 may predict a subsequent trajectory based on a touch via the input apparatus 200 to compensate for (or eliminate) latency. For example, the display apparatus 100 may display both the touch trajectory and the predicted subsequent trajectory (hereinafter, referred to as the predicted trajectory) to provide an effect of displaying a trajectory corresponding to the current position of the input apparatus 200 on the screen. In this regard, by detecting a touch through the input apparatus 200 and displaying the trajectory corresponding to the touch at the same time (or within a very short time), the user is provided with an effect in which the user does not detect latency.

As understood by one of ordinary skill in the art, a prior art display apparatus may have an over-prediction problem in which the prior art display apparatus predicts the subsequent trajectory to be longer than an actual trajectory and displays a trajectory longer than the current position of the input apparatus 200. Furthermore, as understood by one of ordinary skill in the art, the prior art display apparatus may have an under-prediction problem in which the prior art display apparatus predicts the subsequent trajectory to be shorter than an actual trajectory and displays a trajectory shorter than the current position of the input apparatus 200. Due to both the over-prediction and under-prediction problems, the prior art display apparatus fails to accurately compensate for latency.

The prior art display apparatus has a problem of over-predicting or under-predicting a subsequent trajectory depending on whether a touch is detected in a first area (e.g., upper or left portion) on the screen or a second area (e.g., lower or right portion) on the screen.

According to one or more embodiments, the display apparatus 100 may predict the length of a subsequent trajectory equally or unify latency regardless of where on the screen a touch is detected.

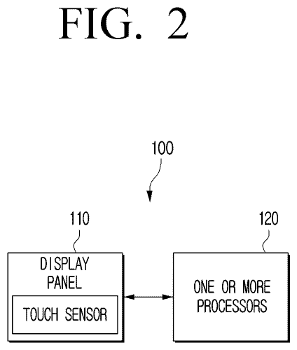

FIG. 2 is a block diagram illustrating configuration of a display apparatus according to one or more embodiments.

Referring to FIG. 2, the display apparatus includes a display panel 110 and one or more processors 120.

According to one or more embodiments, the display panel 110 may be implemented in various forms such as a liquid crystal display (LCD), an organic light-emitting diode (OLED), a liquid crystal on silicon (LCoS), a digital light processing (DLP), a quantum dot (QD) display panel, a quantum dot light-emitting diodes (QLED), a micro light-emitting diodes (μLED), a mini LED, etc.

According to one or more embodiments, the display panel 110 may be implemented as a touch screen combined with a touch sensor 111. In one or more examples, the display panel 110 may be implemented as a flexible display, a rollable display, a 3D display, a modular display in which a plurality of display modules are physically connected, etc.

According to one or more embodiments, the touch sensor 111 may detect a touch on the display panel 110. For example, the touch sensor 111 may detect a touch of any object (e.g., the input apparatus 200) on the display panel 110.

The touch sensor 111 may detect the touch of one or more objects that come into contact with the display panel 110, or may detect only the touch of objects with some limited characteristics. The limitations of objects of which touch can be detected by the touch sensor 111 vary depending on the method by which the touch sensor 111 detects the touch.

In one or more examples, the method by which the touch sensor 111 detects a touch may be implemented as an infrared method using an IR sensor (Infrared Touch Screen), an ultrasonic method (Surface Acoustic Wave Touch Screen), a resistive method (Resistive Touch Screen) (or a pressure-sensitive method), or a capacitive touch method (Capacitive Touch Screen). However, the present disclosure is not limited to these methods, and the touch sensor 111 may detect a touch according to any suitable touch detecting method known to one of ordinary skill in the art. For example, the touch sensor 111 may be equipped with a camera, etc., and may detect a touch on the display panel 110 based on an image captured by the camera.

When a touch is detected on the screen of the display panel 110, the touch sensor 111 according to one embodiment may generate and transmit a signal corresponding to the touch to the one or more processors 120. In one or more examples, the signal corresponding to the touch may include location information (e.g., coordinate information) where the touch was detected on the screen, touch intensity information, or any other suitable information known to one of ordinary skill in the art for predicting a touch trajectory.

According to one or more embodiments, the one or more processors 120 control the overall operations of the display apparatus 100.

For example, the one or more processors 120 may be connected to each configuration of the display apparatus 100 and control the overall operations of the display apparatus 100.

The one or more processors 120 may perform the operations of the electronic apparatus 100 according to various embodiments by executing at least one instruction stored in the memory.

According to one or more embodiments, the one or more processors 120 may include one or more of a central processing unit (CPU), a graphics processing unit (GPU), an accelerated processing unit (APU), a many integrated core (MIC), a digital signal processor (DSP), a neural processing unit (NPU), an Artificial Intelligence (AI) processor, a hardware accelerator, or a machine learning accelerator. In one or more examples, the one or more processors 120 may be implemented as SoC (System on Chip), LSI (large scale integration) with a built-in processing algorithm, or may be implemented in the form of ASIC (application specific integrated circuit), or FPGA (field programmable gate array).

The one or more processors 120 may control one or any combination of the other components of the electronic apparatus, and may perform communication-related operations or data processing. The one or more processors 120 may execute one or more programs or instructions stored in memory. For example, the one or more processors 120 may perform a method according to one or more embodiments by executing one or more instructions stored in the memory.

When a method according to one or more embodiments includes a plurality of operations, the plurality of operations may be performed by one processor or by a plurality of processors. For example, when a first operation, a second operation, and a third operation are performed by the method according to one or more embodiments, all of the first operation, the second operation, and the third operation may be performed by the first processor, or the first operation and the second operation may be performed by the first processor (e.g., a general-purpose processor) and the third operation may be performed by the second processor (e.g., an artificial intelligence-dedicated processor).

The one or more processors 120 may be implemented as a single core processor comprising a single core, or as one or more multicore processors including a plurality of cores (e.g., homogeneous multicore or heterogeneous multicore). When the one or more processors 120 are implemented as multicore processors, each of the plurality of cores included in a multicore processor may include a processor internal memory, such as a cache memory and an on-chip memory, and a common cache shared by the plurality of cores may be included in the multicore processor. Further, each of the plurality of cores (or some of the plurality of cores) included in the multi-core processor may independently read and perform program instructions to implement the method according to one or more embodiments, or all (or some) of the plurality of cores may be coupled to read and perform program instructions to implement the method according to one or more embodiments.

When a method according one or more embodiments includes a plurality of operations, the plurality of operations may be performed by one core of a plurality of cores included in a multi-core processor, or may be performed by a plurality of cores. For example, when a first operation, a second operation, and a third operation are performed by a method according to one or more embodiments, all of the first operation, the second operation, and the third operation may be performed by the first core included in the multi-core processor, or the first operation and the second operation may be performed by the first core included in the multi-core processor and the third operation may be performed by the second core included in the multi-core processor.

In the embodiments of the present disclosure, the processors may be implemented as a system-on-chip (SoC) in which one or more processors and other electronic components are integrated, a single-core processor, a multi-core processor, or a core included in a single-core processor or multi-core processor and here, the core may be implemented as CPU, GPU, APU, MIC, DSP, NPU, hardware accelerator, or machine learning accelerator, etc., but the embodiments of the present disclosure are not limited to these configurations, and may include any suitable processor or system architecture known to one of ordinary skill in the art.

According to one or more embodiments, the one or more processors 120 may control the display panel 110 to display an image by sequentially displaying a plurality of frames included in the image.

For example, the one or more processors 120 may display the plurality of frames sequentially by updating the display panel 110 at time intervals corresponding to a refresh rate.

For example, when the refresh rate is 120 Hz, the one or more processors 120 may update the display panel 110 at a time interval of 1/120=0.0083 [sec] and sequentially display the plurality of frames.

According to one or more embodiments, when a first touch for the screen of the display panel 110 is detected via the touch sensor 111 while displaying a first frame from among the plurality of frames, the one or more processors 120 may obtain a first input point corresponding to the first touch.

According to one or more embodiments, when a second touch for the screen of the display panel 110 is detected via the touch sensor 111 while displaying a second frame from among the plurality of frames, the one or more processors 120 may obtain a second input point corresponding to the second touch.

According to one or more embodiments, the one or more processors 120 may control the display panel 110 to display a touch trajectory based on the first input point and the second input point in a frame subsequent to the second frame using a frame buffer.

According to one or more embodiments, the one or more processors 120 may predict a subsequent trajectory based on the first input point and the second input point.

For example, the one or more processors 120 may obtain a predicted trajectory using various algorithms, such as linear prediction, Taylor series, curve fitting, neural network (NN)-based prediction, etc.

The one or more processors 120, according to one or more embodiments, may adjust the length of the predicted trajectory based on coordinate information corresponding to the first touch within the screen and display continuously on the touch trajectory.

For example, the one or more processors 120 may identify whether the detected first touch is located on the top (or left) side or bottom (or right) side of the display panel 110 while displaying the first frame, and display the predicted trajectory after adjusting the length of the predicted trajectory.

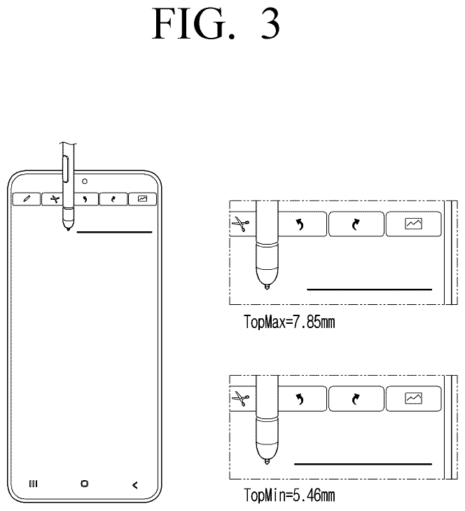

FIG. 3 is a view provided to explain input lag occurring in a first area within a screen of a prior art display apparatus.

Referring to FIG. 3, the one or more processors 120 may update the display panel 110 at time intervals corresponding to the refresh rate and sequentially provide a plurality of frames.

According to one or more embodiments, the one or more processors 120 may update the display panel 110 in a raster scan method during a time interval corresponding to the refresh rate.

For example, the one or more processors 120 may display frames by sequentially updating the display panel 110 from a top to bottom direction, or by sequentially updating the display panel 110 from left to right.

However, the one or more processors 120 is not limited thereto, and may also update the display panel 110 from bottom to top or from right to left.

As shown in FIG. 3, when a touch is detected in a first area of the display panel (e.g., an upper area), the display panel is updated from a top to bottom direction. Therefore, there may be a relatively short latency until a touch trajectory corresponding to the touch is displayed.

For example, when a touch is detected in an upper area of the display panel, a prior art display apparatus may display a touch trajectory and a predicted trajectory corresponding to the detected touch in the next frame of the frame that is being displayed at the time when the touch is detected, and since the upper area arrives at the updating time quickly, an effect in which the difference between the current position of the input apparatus 200 and the predicted trajectory is relatively small (e.g., an effect of short latency) can be provided.

For example, the difference between the current position of the input apparatus 200 and the predicted trajectory may be a maximum of 7.85 mm and a minimum of 5.46 mm. These examples are only for convenience of explanation, and the present disclosure is not limited to specific numbers.

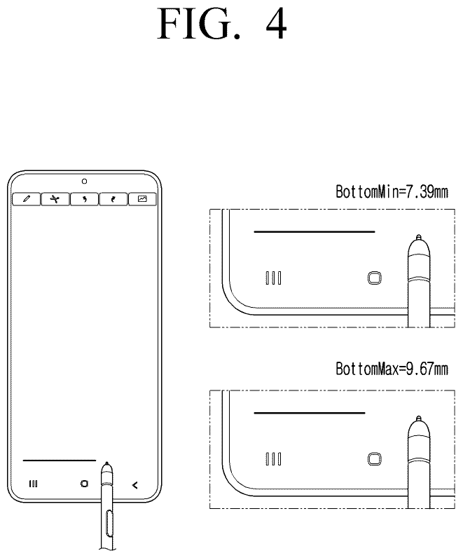

FIG. 4 is a view provided to explain input lag occurring in a second area within a screen of a prior art display apparatus;

Referring to FIGS. 3 and 4, the display apparatus may display frames by sequentially updating the display panel from a top to bottom direction during a time interval corresponding to the refresh rate.

As shown in FIG. 4, when a touch is detected in a second area of the display panel (e.g., a lower area), the display panel is updated from the top to bottom direction. Therefore, there may be a long latency until a touch trajectory corresponding to the touch is displayed.

For example, when a touch is detected in a lower area of the display panel, a prior art display apparatus may display a touch trajectory and a predicted trajectory corresponding to the detected touch in the next frame of the frame that is being displayed at the time when the touch is detected. However, since the updating time is slow, the updating of the lower area results in an effect in which the difference between the current position of the input apparatus 200 and the predicted trajectory is relatively large (e.g., an effect of long latency).

For example, the difference between the current position of the input apparatus 200 and the predicted trajectory may be a maximum of 9.67 mm and a minimum of 7.39 mm. These examples are only for convenience of explanation, and the present disclosure is not limited to specific numbers.

As shown in FIGS. 3 and 4, the prior art display apparatus has a problem in that latency varies depending on whether a touch is detected in a first area or a second area.

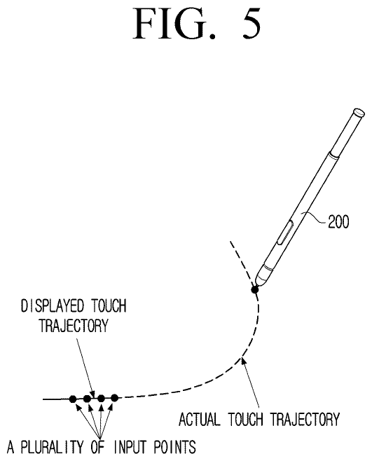

FIG. 5 is a view provided to explain a touch trajectory according to one or more embodiments of the present disclosure.

Referring to FIG. 5, the one or more processors 120 according to one or more embodiments may obtain a touch trajectory based on a plurality of input points, and control the display panel 110 to display the touch trajectory.

The one or more processors 120 according to one or more embodiments may obtain a predicted trajectory based on a plurality of input points, and display the touch trajectory and the predicted trajectory, thereby providing the effect of displaying a trajectory corresponding to the current position of the input apparatus 200.

According to one or more embodiments, the one or more processors 120 may adjust the length of the predicted trajectory and display the trajectory in order to provide the effect in which the same latency occurs regardless of where on the display panel 110 a touch is detected, whether the touch is detected in the upper or lower area.

According to one or more embodiments, when a touch is detected, the one or more processors 120 may obtain a display time between the time of updating the display panel 110 to display the next frame and the time of displaying the touch trajectory in the next frame based on a ratio of the coordinate information of the touch to the size of the screen (e.g., the ratio of the coordinate information of the touch to the size of the screen).

Here, in one or more examples, the next frame is the frame following the frame that the display panel 110 is displaying at the time when the touch is detected, and the one or more processors 120 may display the touch trajectory and the predicted trajectory while the next frame is being displayed.

For example, when a touch is detected in the upper area of the display panel 110, the one or more processors 120 may shorten the length of the predicted trajectory to prevent over-prediction before displaying the same.

For example, when a touch is detected in the lower area of the display panel 110, the one or more processors 120 may lengthen the length of the predicted trajectory to prevent under-prediction before displaying the same.

According to one or more embodiments, the one or more processors 120 may display a predicted trajectory that is similar to an actual touch trajectory with the same latency, regardless of which area of the display panel 110 the touch is detected, without over-prediction or under-prediction.

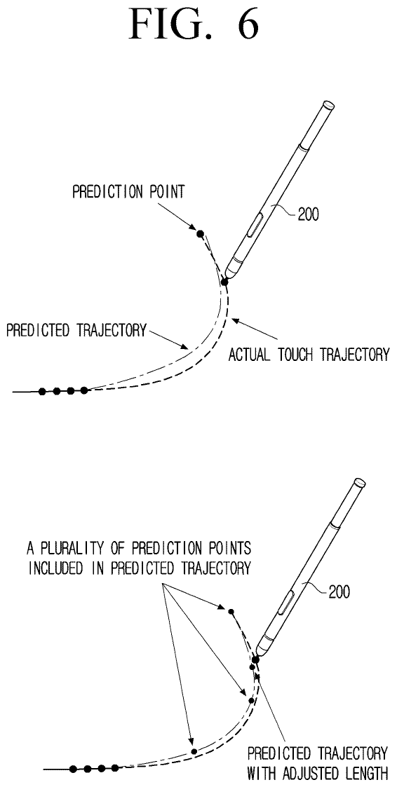

FIG. 6 is a view provided to explain a predicted trajectory according to one or more embodiments.

Referring to FIG. 6, the one or more processors 120 may obtain a touch trajectory based on a plurality of input points, including a first input point corresponding to a first touch, a second input point corresponding to a second touch, etc. Although FIG. 6 illustrates the plurality of input points as discrete points, as understood by one of ordinary skill in the art, the first and second input points may correspond to a position of stylus pen 200 on a touch screen at different timings. For example, referring to FIG. 6, the plurality of input points may correspond to a user performing a swiping motion from left to right where the first input point corresponds to a position of the stylus pen 200 at time t1, and the second input point corresponds to a position of the stylus pen 200 at time t2.

In one or more examples, the one or more processors 120 may input the plurality of input points into various algorithms, such as linear prediction, Taylor series, curve fitting, NN-based prediction, etc. to obtain a predicted trajectory. According to one or more embodiments, the predicted trajectory may include at least one prediction point.

According to one or more embodiments, the one or more processors 120 may obtain a predicted trajectory including a plurality of prediction points, and adjust the length of the predicted trajectory to correspond to the current position (or actual position) of the input apparatus 200 at the time when the predicted trajectory is displayed in the next frame of the frame being displayed at the time when the touch is detected, before displaying the predicted trajectory.

For example, when the display panel 110 is updated from a top to bottom direction during the refresh rate, the one or more processors 120 may obtain a time at which the predicted trajectory is displayed in the next frame (hereinafter, referred to as the display time) based on a ratio of a y-axis coordinate included in the coordinate information to a height of the screen. The y-axis coordinate included in the coordinate information may include a y-axis coordinate of the coordinate information (x, y) corresponding to the first touch detected while the first frame is displayed.

For example, when the display panel 110 is updated from left to right during the refresh rate, the one or more processors 120 may obtain a time at which the predicted trajectory is displayed in the next frame (hereinafter, referred to as the display time) based on a ratio of an x-axis coordinates included in the coordinate information to a width of the screen. The x-axis coordinate included in the coordinate information may include an x-axis coordinate of the coordinate information (x, y) corresponding to the first touch detected while the first frame is displayed.

While the next frame is being displayed, the one or more processors 120 may adjust the length of the predicted trajectory based on the display time before displaying the predicted trajectory.

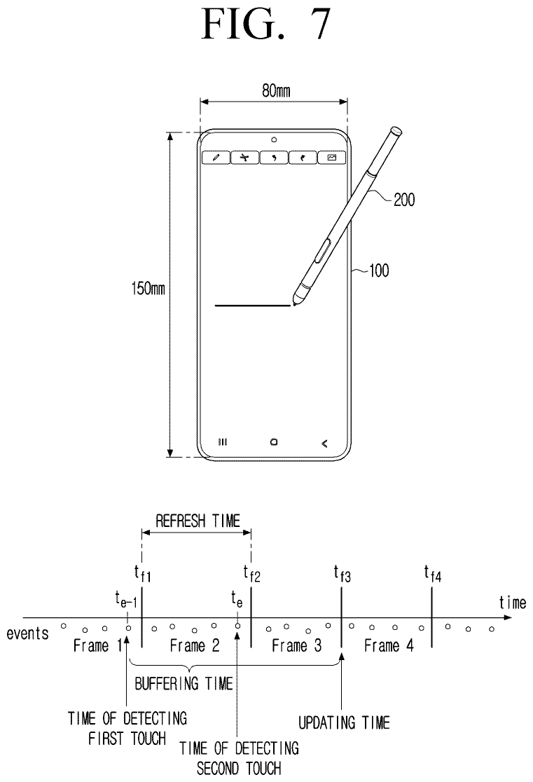

FIG. 7 is a view provided to explain a buffering time according to one or more embodiments.

For convenience of explanation, in one or more examples, the height of the screen is 150 mm, and the width of the screen is 80 mm. However, the present disclosure is not limited to these dimensions, and the height and width of the screen may be changed to any suitable dimension. In one or more examples, the one or more processors 120 may sequentially display each of a plurality of frames by updating the display panel 110 from the top to bottom direction during a time corresponding to the refresh rate (hereinafter, referred to as the refresh time). to sequentially display each of the plurality of frames for a time corresponding to the refresh rate (hereinafter, the refresh time).

According to one or more embodiments, when the first touch is detected while the first frame is displayed, the one or more processors 120 may obtain a first input point corresponding to the first touch.

According to one or more embodiments, when the second touch is detected while the second frame is displayed, the one or more processors 120 may obtain a second input point corresponding to the second touch.

In one or more examples, the time at which the display panel 110 starts updating to display the second frame (hereinafter, referred to as the updating time) (tf1) is 100 ms. The specific numbers are for illustrative purposes only, and the embodiments may be modified to use any suitable parameters.

According to one or more embodiments, the one or more processors 120 may update the display panel 110 during the refresh time to display the second frame. For example, when the refresh rate is 120 Hz, the refresh time is 1/120=0.0083 [sec].

According to one or more embodiments, the one or more processors 120 may obtain a touch trajectory based on the first input point and the second input point, and display the touch trajectory in the next frame subsequent to the second frame.

According to one or more embodiments, the next frame may include a third frame following the second frame or a fourth frame following the third frame, and for convenience of explanation, the next frame will be described below as the fourth frame.

According to one or more embodiments, the one or more processors 120 may obtain a buffering time between the time of detecting the first touch (tₑ₋₁) and the time of updating the display panel 110 to display the fourth frame (t_{f3}), to display a touch trajectory based on the first input point and the second input point.

For example, the one or more processors 120 may obtain a buffering time based on Equation 1 below.

$$buffering time = {t}_{1} + {t}_{2} + {t}_{3} + {t}_{4} , \qquad [ Equation 1 ]$$

In one or more examples, t₁ is the difference between the times when a touch via the input apparatus 200 is detected (e.g., the time of detecting the second touch (tₑ)—the time of detecting the first touch (tₑ₋₁).

In one or more examples, t₂ is the difference between the time when a touch via the input apparatus 200 is detected and the time when a frame buffer is prepared to display the next frame (e.g., the time when the display panel 110 is updated to display the third frame (t_{f2})—the time when the second touch is detected (tₑ)).

In one or more examples, t₃ is the refresh time or the time required for the frame buffer to display the next frame (e.g., the time of updating the display panel 110 to display the fourth frame (t_{f3})—the time of updating the display panel 110 to display the third frame (t_{f2})).

In one or more examples, t₄ is, when the display panel 110 performs an adaptive synchronization function (e.g., G-Sync, FreeSync), the time required to perform the adaptive synchronization function.

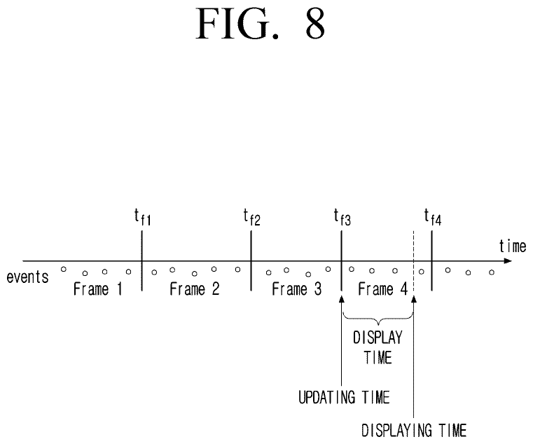

FIG. 8 is a view provided to explain a display time according to one or more embodiments.

Referring to FIG. 8, the one or more processors 120 sequentially update the display panel 110 from a top to bottom direction, so that depending on the position where a touch trajectory is displayed within the screen, a display time occurs between the time of updating the display panel 110 and the time of displaying the touch trajectory.

For example, the one or more processors 120 may obtain a display time based on Equation 2 below.

$$display time = ( PC / DS ) - FTI , \qquad [ Equation 2 ]$$

In one or more examples, the parameter PC is coordinate information corresponding to the first touch.

In one or more examples, the display size (DS) is the size of the screen.

In one or more examples, the frame time interval (FTI) is the refresh time.

In one or more examples, while the fourth frame is being displayed, the one or more processors 120 may display the touch trajectory, and identify the time from the time of updating the display panel 110 to display the fourth frame (t_{f3}) to the time of displaying the touch trajectory (or the time when the area where the touch trajectory is located in the display panel 110 is updated) as the display time.

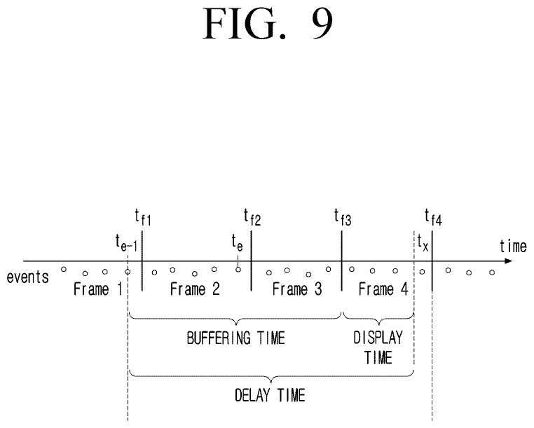

FIG. 9 is a view provided to explain a delay time according to one or more embodiments.

Referring to FIG. 9, the one or more processors 120 may obtain, based on the buffering time and the display time, a delay time between the time of detecting the first touch and the time of displaying the touch trajectory.

For example, the height of the screen may be 150 mm, the width of the screen may be 80 mm, and the coordinate information corresponding to the first touch may be 40, 75.

In one or more examples, the time to start updating the display panel 110 to display the second frame (hereinafter, referred to as the updating time) (t_{f1}) may be 100 ms, the time of updating the display panel 110 to display the third frame (t_{f2}) may be 108.3 ms (=100 ms+8.3 ms), and the time of updating the display panel 110 to display the fourth frame (t_{f3}) may be 116.6 ms (=100 ms+16.6 ms).

In one or more examples, the time of detecting the first touch (tₑ₋₁) may be 98 ms, and the time of detecting the second touch (tₑ) may be 106 ms.

According to one or more embodiments, the one or more processors 120 may obtain a buffering time based on Equation 1.

$${t}_{1} = {t}_{e} - {t}_{e - 1} = 106 - 98 = 8 ms ,$$

$${t}_{2} = {t}_{f 2} - {t}_{e} = 10 8.3 - 106 = 2.3 ms$$

$${t}_{3} = {t}_{f 3} - {t}_{f 2} = 11 6.6 - 10 \; 8.3 = 8.3 ms ,$$

t₄=0 (assuming that no adaptive synchronization function is performed).
buffering time=t₁+t₂+t₃+t₄=8+2.3+8.3+0=18.6 ms

According to one or more embodiments, the one or more processors 120 may obtain a display time based on Equation 2.

display time=y-axis coordinates/height*FTI(frame time interval)=75/150*8.33=4.17 ms

In one or more examples, the display panel 110 may also be updated from a left to right direction, rather than a top to bottom direction, and the display time may be obtained by calculating the x-axis coordinate/width*FTI.

According to one or more embodiments, the one or more processors 120 may obtain a delay time using the buffering time and the display time based on Equation 3 below.

delay time=min(buffering time+FTI,PT)−(FTI-display time)

In one or more examples, the parameter PT is a prediction time corresponding to a prediction point.

For example, PT may include a prediction time (or prediction time point) corresponding to a prediction point based on the time of detecting the first touch (tₑ₋₁).

For example, the one or more processors 120 may obtain a predicted trajectory including at least one prediction point by using one of the aforementioned algorithms. For example, using one of the aforementioned algorithms, the one or more processors 120 obtains a predicted trajectory including three prediction points.

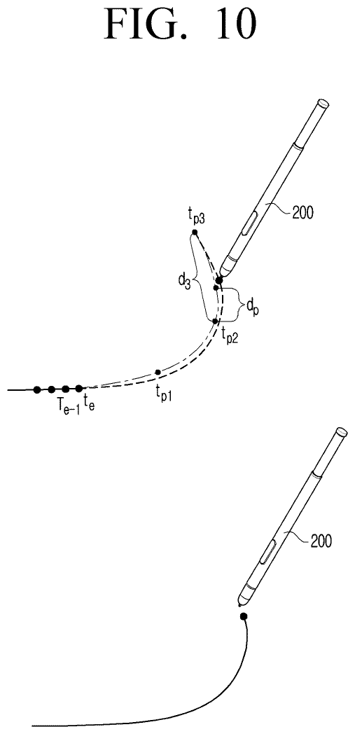

FIG. 10 is a view provided to explain a display apparatus that displays a predicted trajectory with an adjusted length according to one or more embodiments.

Referring to FIG. 10, the one or more processors 120 may obtain a first prediction point, a second prediction point, and a third prediction point based on the first input point corresponding to the first touch and the second input point corresponding to the second touch.

For convenience of explanation, it is assumed that the prediction time corresponding to the first prediction point (tₚ₁) is 8 ms, the prediction time corresponding to the second prediction point (tₚ₂) is 16 ms, and the prediction time corresponding to the third prediction point (tₚ₃) is 29 ms.

According to one or more embodiments, the one or more processors 120 may compare the delay time with the prediction time corresponding to the prediction point.

As calculated in FIG. 9, the one or more processors 120 may compare the sum of the buffering time and the refresh time (buffering time+FTI) (e.g., 26.9 (=18.6+8.3)) with the prediction time (PT).

For example, when the sum of the buffering time and the refresh time is less than the prediction time, the one or more processors 120 may adjust the length of the predicted trajectory based on the delay time and display a portion of the predicted trajectory.

In one or more examples, the delay time=min (buffering time+FTI, PT)−(FTI−display time)=min (26.9, the prediction time corresponding to the third prediction point (tₚ₃))−(8.3−4.17)=26.9−4.16=22.83 ms, and

$${d}_{p} = ( delay time - {t}_{p 2} ) / ( {t}_{p 3} - {t}_{p 2} ) * {d}_{3} = ( 22 \text{.83} - 16 ) / ( 29 - 16 ) * {d}_{3} = 0.525 * {d}_{3}$$

According to one or more embodiments, since the sum of the buffering time and the refresh time (buffering time+FTI) is longer than the prediction time corresponding to the second prediction point (tₚ₂) and shorter than the prediction time corresponding to the third prediction point (tₚ₃), the one or more processors 120 may adjust the length of the total predicted trajectory by adjusting the length of the predicted trajectory (d₃) between the second prediction point and the third prediction point.

For example, the one or more processors 120 may obtain a first prediction point and a second prediction point based on the first input point corresponding to the first touch and the second input point corresponding to the second touch, and may assume that the prediction time corresponding to the first prediction point (tₚ₁) is 8 ms, and the prediction time corresponding to the second prediction point (tₚ₂) is 16 ms.

delay time=min (buffering time+FTI, PT)−(FTI−display time)=min (26.9, the prediction time corresponding to the second prediction point (tₚ₂))−(8.3−4.17)=16−4.16=11.87 ms

$${d}_{p} = ( delay time - {t}_{p 1} ) / ( {t}_{p 2} - {t}_{p 1} ) * {d}_{2} = ( 11.87 - 8 ) / ( 16 - 8 ) * {d}_{2} = 0.48 * {d}_{2}$$

According to one or more embodiments, since the delay time is longer than the prediction time corresponding to the first prediction point (tₚ₁) and shorter than the prediction time corresponding to the second prediction point (tₚ₂), the one or more processors 120 may adjust the length of the total predicted trajectory by adjusting the length of the predicted trajectory (d₂) between the first prediction point and the second prediction point.

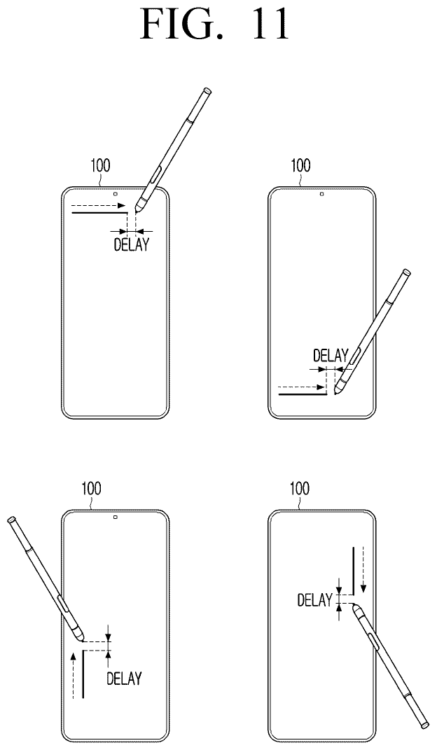

FIG. 11 is a view provided to explain input lag occurring in a display apparatus that updates a frame in various directions according to one or more embodiments.

Referring to FIG. 11, the display panel 110 may be refreshed from a top to bottom direction or from a bottom to top direction.

According to one or more embodiments, the one or more processors 120 may adjust the length of the predicted trajectory based on the time (e.g., display time) delayed until displaying the touch trajectory and the predicted trajectory according to coordinate information corresponding to the first touch through the input apparatus 200 within the screen, for example, along the y-axis coordinate, before displaying the predicted trajectory.

According to one or more embodiments, the display panel 110 may display the predicted trajectory with the same latency whether the touch is detected in the upper area or the lower area.

In one or more examples, the display panel 110 may be refreshed from a left to right direction or from a right to left direction.

According to one or more embodiments, the one or more processors 120 may adjust the length of the predicted trajectory based on the time delayed until displaying the touch trajectory and the predicted trajectory according to coordinate information corresponding to the first touch through the input apparatus 200 within the screen, for example, along the x-axis coordinate, before displaying the predicted trajectory.

According to one or more embodiments, the display panel 110 may display the predicted trajectory with the same latency whether the touch is detected in the left area or the right area.

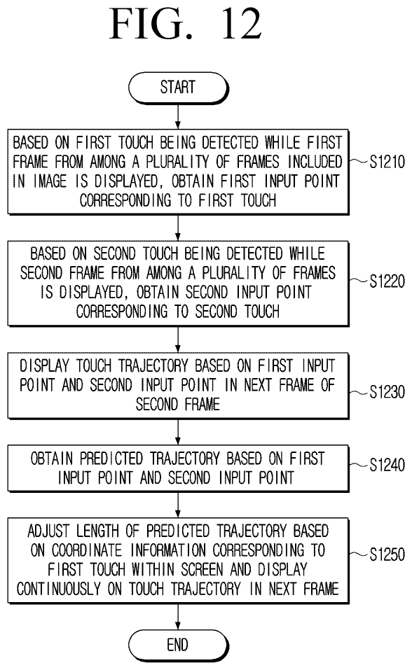

FIG. 12 is a flowchart provided to explain a controlling method of a display apparatus according to one or more embodiments.

Referring to FIG. 12, a controlling method of a display apparatus includes, when a first touch for the screen is detected while displaying a first frame among a plurality of frames included in an image, a first input point corresponding to the first touch is obtained (S1210).

When a second touch for the screen is detected while displaying a second frame among the plurality of frames, a second input point corresponding to the second touch is obtained (S1220).

In the next frame of the second frame, a touch trajectory based on the first input point and the second input point is displayed (S1230).

A predicted trajectory based on the first input point and the second input point is obtained (S1240).

In the next frame, the length of the predicted trajectory is adjusted based on coordinate information corresponding to the first touch within the screen and displayed continuously on the touch trajectory (S1250).

The controlling method according to one or more embodiments may further include the operation of updating the display panel from the top to bottom direction or left to right direction during the refresh rate to sequentially display each of a plurality of frames, and the operation of adjusting the length of the predicted trajectory before displaying the same (S1250) may include obtaining a display time between the time of updating the display panel to display the next frame and the time of displaying the touch trajectory in the next frame based on a ratio of the coordinate information to the size of the screen.

The operation of obtaining the display time according to one or more embodiments may include, when updating the display panel from a top to bottom direction during the refresh rate, obtaining the display time based on a ratio of the y-axis coordinates included in the coordinate information for the height of the screen, and the operation of adjusting the length of the predicted trajectory before displaying the same (S1250) may include adjusting the length of the predicted trajectory based on the display time in the next frame.

The operation of obtaining the display time according to one or more embodiments may include, when updating the display panel from left to right during the refresh rate, obtaining the display time based on a ratio of the x-axis coordinates included in the coordinate information for the width of the screen, and the operation of adjusting the length of the predicted trajectory before displaying the same (S1250) may include adjusting the length of the predicted trajectory based on the display time in the next frame.

The operation of adjusting the length of the predicted trajectory before displaying the same according to one or more embodiments (S1250) may include obtaining a buffering time between the time of detecting the first touch and the updating time and adjusting the length of the predicted trajectory based on the buffering time and the display time.

The operation of adjusting the length of the predicted trajectory before displaying the same according to one or more embodiments (S1250) may include obtaining a delay time between the time of detecting the first touch and the time of displaying the touch trajectory based on the buffering time and the display time and adjusting the length of the predicted trajectory by comparing the prediction time corresponding to the prediction point included in the predicted trajectory with the delay time.

The operation of adjusting the length of the predicted trajectory before displaying the same according to one or more embodiments (S1250) may include, when the sum of the refresh time corresponding to the refresh rate and the buffering time is less than the prediction time, adjusting the length of the predicted trajectory based on the delay time to display a portion of the predicted trajectory.

The operation of adjusting the length of the predicted trajectory before displaying the same according to one or more embodiments (S1250) may include, when the prediction time is less than the sum of the refresh time and the buffering time, displaying a portion of the predicted trajectory based on the prediction time, the refresh time, and the display time.

The operation of adjusting the length of the predicted trajectory before displaying the same according to one or more embodiments (S1250) may include, when the delay time is included between a first prediction time corresponding to a first prediction point and a second prediction time corresponding to a second prediction point included in the prediction trajectory, adjusting the length of the prediction trajectory to a length between the first prediction point and the second prediction point based on the delay time.

The controlling method according to one or more embodiments may further include, when the display panel performs an adaptive synchronization function, adding to the buffering time the time required to perform the adaptive synchronization function.

It should be appreciated that various embodiments of the present disclosure can be applied not only to display apparatuses but also to various types of electronic apparatuses capable of detecting a touch.

In one or more examples, the above-described various embodiments may be implemented in a recording medium that can be read by a computer or a similar device using software, hardware, or a combination thereof. In some cases, embodiments described herein may be implemented by a processor itself. According to software implementation, embodiments such as procedures and functions described in this specification may be implemented as separate software modules. Each of the software modules may perform one or more functions and operations described in this disclosure.

In one or more examples, computer instructions for performing processing operations of a robot device according to the above-described various embodiments may be stored in a non-transitory computer-readable medium. When being executed by a processor of a specific device, the computer instructions stored in such a non-transitory computer-readable medium allows the specific device to perform processing operations in a robot device 100 according to the above-described various embodiments.

The non-transitory computer-readable medium refers to a medium that stores data semi-permanently and can be read by a device, rather than a medium that stores data for a short period of time, such as registers, caches, memory, etc. Specific examples of the non-transitory computer-readable medium may include CD, DVD, hard disk, Blu-ray disk, USB, memory card, ROM, etc.

Although preferred embodiments of the present disclosure have been shown and described above, the disclosure is not limited to the specific embodiments described above, and various modifications may be made by one of ordinary skill in the art without departing from the spirit of the disclosure as claimed in the claims, and such modifications are not to be understood in isolation from the technical ideas or prospect of the disclosure.

What is claimed is:

1. A display apparatus comprising:
memory storing one or more instructions;
a display panel comprising a touch sensor; and
at least one processor operatively coupled to the memory and the display panel and configured to execute the one or more instructions,
wherein the one or more instructions, when executed by the at least one processor, cause the display apparatus to:
based on a first touch on a screen of the display panel being detected through the touch sensor while a first frame from among a plurality of frames included in an image is displayed by the display panel, obtain a first input point corresponding to the first touch,
based on a second touch on the screen being detected while a second frame from among the plurality of frames is displayed by the display panel, obtain a second input point corresponding to the second touch,
display, on the display panel, a touch trajectory based on the first input point and the second input point in a next frame subsequent to the second frame,
obtain a predicted trajectory based on the first input point and the second input point,
adjust a length of the predicted trajectory based on coordinate information corresponding to the first touch within the screen, and
display, on the display panel, the predicted trajectory with the adjusted length with the touch trajectory in the next frame such that the touch trajectory and the predicted trajectory with the adjusted length form a continuous trajectory in the next frame.

2. The display apparatus as claimed in claim 1, wherein the one or more instructions, when executed by the at least one processor, cause the display apparatus to:
update the display panel from a top to bottom direction or a left to right direction during a refresh rate and display each of the plurality of frames sequentially, and
obtain a display time between a time of updating the display panel for displaying the next frame and a time of displaying the touch trajectory in the next frame based on a ratio of the coordinate information to a size of the screen.

3. The display apparatus as claimed in claim 2, wherein the one or more instructions, when executed by the at least one processor, cause the display apparatus to:
based on the display panel being updated from the top to bottom direction during the refresh rate, obtain the display time based on a ratio of a y-axis coordinate included in the coordinate information to a height of the screen, and
adjust the length of the predicted trajectory based on the display time in the next frame.

4. The display apparatus as claimed in claim 2, wherein the one or more instructions, when executed by the at least one processor, cause the display apparatus to:
based on the display panel being updated from the left to right direction during the refresh rate, obtain the display time based on a ratio of an x-axis coordinate included in the coordinate information to a width of the screen, and
adjust the length of the predicted trajectory based on the display time in the next frame.

5. The display apparatus as claimed in claim 2, wherein the one or more instructions, when executed by the at least one processor, cause the display apparatus to:
obtain a buffering time between a time of detecting the first touch and the time of updating the display panel, and
adjust the length of the predicted trajectory based on the buffering time and the display time.

6. The display apparatus as claimed in claim 5, wherein the one or more instructions, when executed by the at least one processor, cause the display apparatus to:
obtain a delay time between a time of detecting the first touch and a time of displaying the touch trajectory based on the buffering time and the display time, and
adjust the length of the predicted trajectory by comparing a prediction time corresponding to a prediction point included in the predicted trajectory with the delay time.

7. The display apparatus as claimed in claim 6, wherein the one or more instructions, when executed by the at least one processor, cause the display apparatus to:
based on a sum of a refresh time corresponding to the refresh rate and the buffering time being less than the prediction time, display a portion of the predicted trajectory by adjusting the length of the predicted trajectory based on the delay time.

8. The display apparatus as claimed in claim 6, wherein the one or more instructions, when executed by the at least one processor, cause the display apparatus to:
based on the prediction time being less than a sum of a refresh time corresponding to the refresh rate and the buffering time, display a portion of the predicted trajectory based on the prediction time, the refresh time, and the display time.

9. The display apparatus as claimed in claim 6, wherein the one or more instructions, when executed by the at least one processor, cause the display apparatus to:
based on the delay time being included between a first prediction time corresponding to a first prediction point included in the predicted trajectory and a second prediction time corresponding to a second prediction point in the predicted trajectory, adjust the length of the predicted trajectory to a length between the first prediction point and the second prediction point.

10. The display apparatus as claimed in claim 1, wherein the one or more instructions, when executed by the at least one processor, cause the display apparatus to:
based on the display panel performing an adaptive synchronization function, add a time required to perform the adaptive synchronization function to a buffering time.

11. A controlling method of a display apparatus, the method comprising:
based on a first touch on a screen of a display panel of the display apparatus being detected while a first frame from among a plurality of frames included in an image is displayed, obtaining a first input point corresponding to the first touch;
based on a second touch on the screen being detected while a second frame from among the plurality of frames is displayed, obtaining a second input point corresponding to the second touch;
displaying a touch trajectory based on the first input point and the second input point in a next frame subsequent to the second frame;
obtaining a predicted trajectory based on the first input point and the second input point;
adjusting a length of the predicted trajectory based on coordinate information corresponding to the first touch within the screen; and
displaying the predicted trajectory with the adjusted length with the touch trajectory in the next frame such that the touch trajectory and the predicted trajectory with the adjusted length form a continuous trajectory in the next frame.

12. The method as claimed in claim 11, further comprising:
updating the display panel from a top to bottom direction or left to right direction during a refresh rate and displaying each of the plurality of frames sequentially;
wherein the adjusting the length of the predicted trajectory comprises obtaining a display time between a time of updating the display panel for displaying the next frame and a time of displaying the touch trajectory in the next frame based on a ratio of the coordinate information to a size of the screen.

13. The method as claimed in claim 12, wherein the obtaining the display time comprises, based on the display panel being updated from the top to bottom direction during the refresh rate, obtaining the display time based on a ratio of a y-axis coordinate included in the coordinate information to a height of the screen, and
wherein the adjusting the length of the predicted trajectory further comprises adjusting the length of the predicted trajectory based on the display time in the next frame.

14. The method as claimed in claim 12, wherein the obtaining the display time comprises, based on the display panel being updated from left to right during the refresh rate, obtaining the display time based on a ratio of an x-axis coordinate included in the coordinate information to a width of the screen, and
wherein the adjusting the length of the predicted trajectory further comprises adjusting the length of the predicted trajectory based on the display time in the next frame.

15. The method as claimed in claim 12, wherein the adjusting the length of the predicted trajectory further comprises:
obtaining a buffering time between a time of detecting the first touch and the time of updating the display panel; and
adjusting the length of the predicted trajectory based on the buffering time and the display time.

16. A non-transitory computer readable medium, having instructions stored therein, which when executed by a processor a display apparatus, cause the processor to execute a method comprising:
based on a first touch on a screen of a display panel of the display apparatus being detected while a first frame from among a plurality of frames included in an image is displayed, obtaining a first input point corresponding to the first touch;
based on a second touch on the screen being detected while a second frame from among the plurality of frames is displayed, obtaining a second input point corresponding to the second touch;
displaying a touch trajectory based on the first input point and the second input point in a next frame subsequent to the second frame,
obtaining a predicted trajectory based on the first input point and the second input point;
adjusting a length of the predicted trajectory based on coordinate information corresponding to the first touch within the screen; and
displaying the predicted trajectory with the adjusted length with the touch trajectory in the next frame such that the touch trajectory and the predicted trajectory with the adjusted length form a continuous trajectory in the next frame.

17. The non-transitory computer readable medium as claimed in claim 16, wherein the method further comprises:
updating the display panel from a top to bottom direction or left to right direction during a refresh rate and displaying each of the plurality of frames sequentially;
wherein the adjusting the length of the predicted trajectory and the displaying comprises obtaining a display time between a time of updating the display panel for displaying the next frame and a time of displaying the touch trajectory in the next frame based on a ratio of the coordinate information to a size of the screen.

18. The non-transitory computer readable medium as claimed in claim 17, wherein the obtaining the display time comprises, based on the display panel being updated from the top to bottom direction during the refresh rate, obtaining the display time based on a ratio of a y-axis coordinate to a height of the screen, the y-axis coordinate included in the coordinate information, and
wherein the adjusting the length of the predicted trajectory and the displaying comprises adjusting the length of the predicted trajectory based on the display time in the next frame.

19. The non-transitory computer readable medium as claimed in claim 17, wherein the obtaining the display time comprises, based on the display panel being updated from left to right during the refresh rate, obtaining the display time based on a ratio of an x-axis coordinate to a width of the screen, the x-axis coordinate included in the coordinate information, and
wherein the adjusting the length of the predicted trajectory and the displaying comprises, adjusting the length of the predicted trajectory based on the display time in the next frame.

20. The non-transitory computer readable medium as claimed in claim 17, wherein the adjusting the length of the predicted trajectory and the displaying comprises:
obtaining a buffering time between a time of detecting the first touch and the updating time; and
adjusting the length of the predicted trajectory based on the buffering time and the display time.
